(19) United States
(12) Patent Application Publication
(10) Pub. No.: US 2020/0286479 A1
(43) Pub. Date: Sep. 10, 2020

(54) AGENT DEVICE, METHOD FOR CONTROLLING AGENT DEVICE, AND STORAGE MEDIUM

(71) Applicant: HONDA MOTOR CO., LTD., Tokyo (JP)

(72) Inventors: Masaki Kurihara, Wako-shi (JP); Shinichi Kikuchi, Wako-shi (JP); Hiroshi Honda, Wako-shi (JP); Mototsugu Kubota, Wako-shi (JP); Yusuke Oi, Tokyo (JP)

(21) Appl. No.: 16/807,255

(22) Filed: Mar. 3, 2020

(30) Foreign Application Priority Data
Mar. 7, 2019 (JP) 2019-041771

(51) Int. Cl. G10L 15/22; B60K 35/00; G06F 3/16

(52) U.S. Cl. CPC G10L 15/22; B60K 35/00; G06F 3/167; B60K 2370/1575; G10L 2015/225; B60K 2370/148; G10L 2015/223

(57) ABSTRACT

An agent device includes: a plurality of agent function units, each of the plurality of agent function units being configured to provide services including outputting a response to an output unit in response to an utterance of an occupant of a vehicle; a recognizer configured to recognize a request included in the occupant's utterance; and an agent selector configured to output a request recognized by the recognizer to the plurality of agent function units and select an agent function unit which outputs a response to the occupant's utterance to the output unit among the plurality of agent function units on the basis of the result of a response of each of the plurality of agent function units.

### CROSS-REFERENCE TO RELATED APPLICATION

Priority is claimed on Japanese Patent Application No. 2019-041771, filed Mar. 7, 2019, the content of which is incorporated herein by reference.

### BACKGROUND

### Field of the Invention

The present invention relates to an agent device, a method for controlling the agent device, and a storage medium.

### Description of Related Art

In the related art, a technology related to an agent function for providing information about driving assistance according to an occupant's request, control of the vehicle, other applications, and the like while interacting with the occupant of a vehicle is described (Japanese Unexamined Patent Application, First Publication No. 2006-335231).

In recent years, practical use of a plurality of agents installed in vehicles has been promoted, but it is necessary for the occupant to call one agent and transmit a request even though a plurality of agents are installed in one vehicle. For this reason, if the occupant does not know the characteristics of each agent, the occupant cannot call the most suitable agent to perform the processing for the request and cannot obtain an appropriate result in some cases.

### SUMMARY

The present invention was made in consideration of such circumstances, and an object of the present invention is to provide an agent device, a method for controlling the agent device, and a storage medium capable of providing a more appropriate response result.

An agent device, a method for controlling the agent device, and a storage medium according to the present invention employ the following constitutions.

(1) An agent device according to an aspect of the present invention includes: a plurality of agent function units, each of the plurality of agent function units being configured to provide services including outputting a response to an output unit in response to an utterance of an occupant of a vehicle; a recognizer configured to recognize a request included in the occupant's utterance; and an agent selector configured to output a request recognized by the recognizer to the plurality of agent function units and select an agent function unit which outputs a response to the occupant's utterance to the output unit among the plurality of agent function units on the basis of the results of a response of each of the plurality of agent function units.

(2) In the aspect of the above (1), an agent device includes: a plurality of agent function units, each of the plurality of agent function units including a voice recognizer which recognizes a request included in an utterance of an occupant of a vehicle and configured to provide a service including outputting a response to an output unit in response to the occupant's utterance; and an agent selector configured to select an agent function unit which outputs a response to the occupant's utterance to the output unit on the basis of the result of a response of each of the plurality of agent function units with respect to the utterance of the occupant of the vehicle.

(3) In the aspect of the above (2), each of the plurality of agent function units includes a voice receiver configured to receive a voice of the occupant's utterance and a processor configured to perform processing on a voice received by the voice receiver.

(4) In the aspect of the above (1), the agent device further includes: a display controller configured to cause a display unit to display the result of the response of each of the plurality of agent function units.

(5) In the aspect of the above (1), the agent selector preferentially selects an agent function unit in which a time between an utterance timing of the occupant and a response is short among the plurality of agent function units.

(6) In the aspect of the above (1), the agent selector preferentially selects an agent function unit a high certainty factor of the response of the occupant's utterance among the plurality of agent function units.

(7) In the aspect of the above (6), the agent selector normalizes the certainty factor and selects the agent function unit on the basis of the normalized result.

(8) In the aspect of the above (4), the agent selector preferentially selects an agent function unit acquired through the response result by the occupant among the results of the responses of the plurality of agent function units displayed by the display unit.

(9) A method for controlling an agent device according to another aspect of the present invention causing a computer to execute: starting-up a plurality of agent function units; providing services including outputting a response to an output unit in response to an utterance of an occupant of a vehicle as functions of the started-up agent function units; recognizing a request included in the occupant's utterance; and outputting the recognized request to the plurality of agent function units and selecting an agent function unit which outputs a response to the occupant's utterance to the output unit among the plurality of agent function units on the basis of the result of the response of each of the plurality of agent function units.

(10) A method for controlling an agent device according to still another aspect of the present invention causing a computer to execute: starting-up a plurality of agent function units each including a voice recognizer configured to recognize a request included in an utterance of an occupant of a vehicle; providing services including outputting a response to an output unit in response to the occupant's utterance as functions of the started-up agent function units; and selecting an agent function unit which outputs a response to the occupant's utterance to the output unit on the basis of the result of a response of each of the plurality of agent function units with respect to the utterance of the occupant of the vehicle.

According to the above (1) to (10), it is possible to provide a more appropriate response result.

### BRIEF DESCRIPTION OF THE DRAWINGS

FIG. 1 is a constitution diagram of an agent system including agent devices.

FIG. 2 is a diagram illustrating a constitution of an agent device according to a first embodiment and an apparatus installed in a vehicle.

FIG. 3 is a diagram illustrating an arrangement example of a display/operation device and a speaker unit.

FIG. 4 is a diagram illustrating a constitution of an agent server and a part of a constitution of an agent device.

FIG. 5 is a diagram for explaining processing of the agent selector.

FIG. 6 is a diagram for explaining selection of an agent function unit on the basis of the certainty factor of a response result.

FIG. 7 is a diagram illustrating an example of an image IM1 displayed on the first display as an agent selection screen.

FIG. 8 is a diagram illustrating an example of an image IM2 displayed using the display controller in a scene before an occupant utters.

FIG. 9 is a diagram illustrating an example of an image IM3 displayed using the display controller in a scene when the occupant performs an utterance including a command.

FIG. 10 is a diagram illustrating an example of an image IM4 displayed using the display controller in a scene in an agent is selected.

FIG. 11 is a diagram illustrating an example of an image IM5 displayed using the display controller in a scene in which an agent image has been selected.

FIG. 12 is a flowchart for describing an example of a flow of a process performed using the agent device in the first embodiment.

FIG. 13 is a diagram illustrating a constitution of an agent device according to a second embodiment and an apparatus installed in the vehicle.

FIG. 14 is a diagram illustrating a constitution of an agent server according to the second embodiment and a part of the constitution of the agent device.

FIG. 15 is a flowchart for describing an example of a flow of a process performed using the agent device in the second embodiment.

### DESCRIPTION OF EMBODIMENTS

Embodiments of an agent device, a method for controlling the agent device, and a storage medium of the present invention will be described below with reference to the drawings. The agent device is a device configured to realize a part or all of an agent system. As an example of the agent device, an agent device installed in a vehicle (hereinafter referred to as a “vehicle M”) and including a plurality of types of agent functions will be described below. Examples of the agent functions include a function of providing various types of information based on a request (a command) included in an occupant's utterance or mediating a network service while interacting with the occupant of the vehicle M. Some of the agent functions may have a function of controlling an apparatus in the vehicle (for example, an apparatus related to driving control and vehicle body control).

The agent functions are realized, for example, by integrally using a natural language processing function (a function of understanding a structure and the meaning of text), a dialog management function, a network retrieval function of retrieving another device over a network or retrieving a predetermined database owned by a subject device, and the like, in addition to a voice recognition function of recognizing the occupant's voice (a function of converting a voice into text). Some or all of these functions may be realized using an artificial intelligence (AI) technology. A part of a constitution for performing these functions (particularly, a voice recognition function and a natural language processing interpretation function) may be installed in an agent server (an external device) capable of communicating with the in-vehicle communication device of the vehicle M or a general-purpose communication device brought into the vehicle M.

In the following description, it is assumed that a part of a constitution is installed in the agent server and the agent system is realized in cooperation with the agent device and the agent server. A service providing entity (a service entity) which virtually appears in cooperation with the agent device and the agent server is referred to as an agent.

<Overall Constitution>

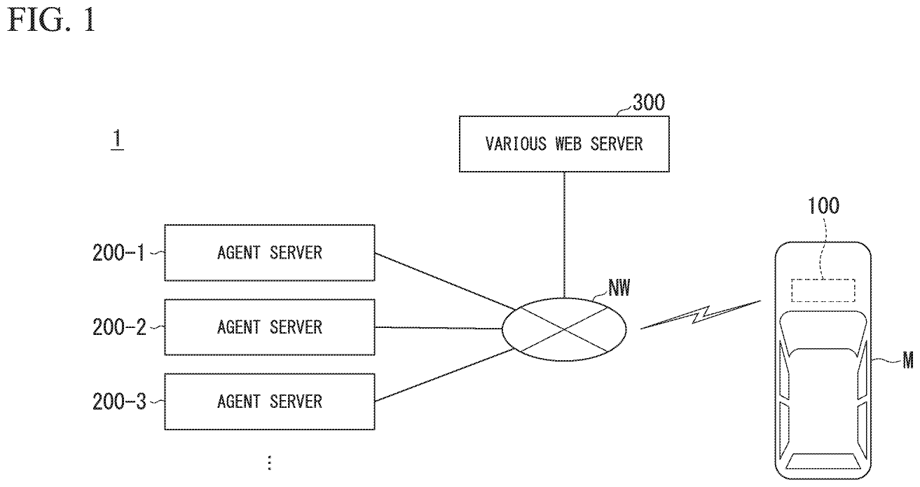

FIG. 1 is a constitution diagram of an agent system 1 including an agent device 100. The agent system 1 includes, for example, the agent device 100 and a plurality of agent servers 200-1, 200-2, 200-3, . . . . It is assumed that the number following the hyphen at the end of the code is an identifier for distinguishing the agent. When it is not necessary to distinguish between agent servers, the agent servers are simply referred to as an agent server 200 or agent servers 200 in some cases. Although FIG. 1 illustrates three agent servers 200, the number of agent servers 200 may be two or four or more. The agent servers 200 are operated by, for example, different agent system providers. Therefore, agents in the present embodiment are agents realized by different providers. Examples of the providers include automobile manufacturers, network service providers, e-commerce providers, sellers of a mobile terminal, and the like and an arbitrary entity (a corporation, a group, an individual, or the like) can be a provider of the agent system.

The agent device 100 communicates with each of the agent servers 200 over a network NW. Examples of the network NW include some or all of the Internet, a cellular network, a Wi-Fi network, a wide area network (WAN), a local area network (LAN), a public circuit, a telephone circuit, a wireless base station, and the like. Various web servers 300 are connected to the network NW and the agent servers 200 or the agent device 100 can acquire web pages from various web servers 300 over the network NW.

The agent device 100 interacts with the occupant of the vehicle M, transmits a voice from the occupant to the agent server 200, and presents an answer obtained from the agent server 200 to the occupant in the form of a voice output or image display.

### First Embodiment

### [Vehicle]

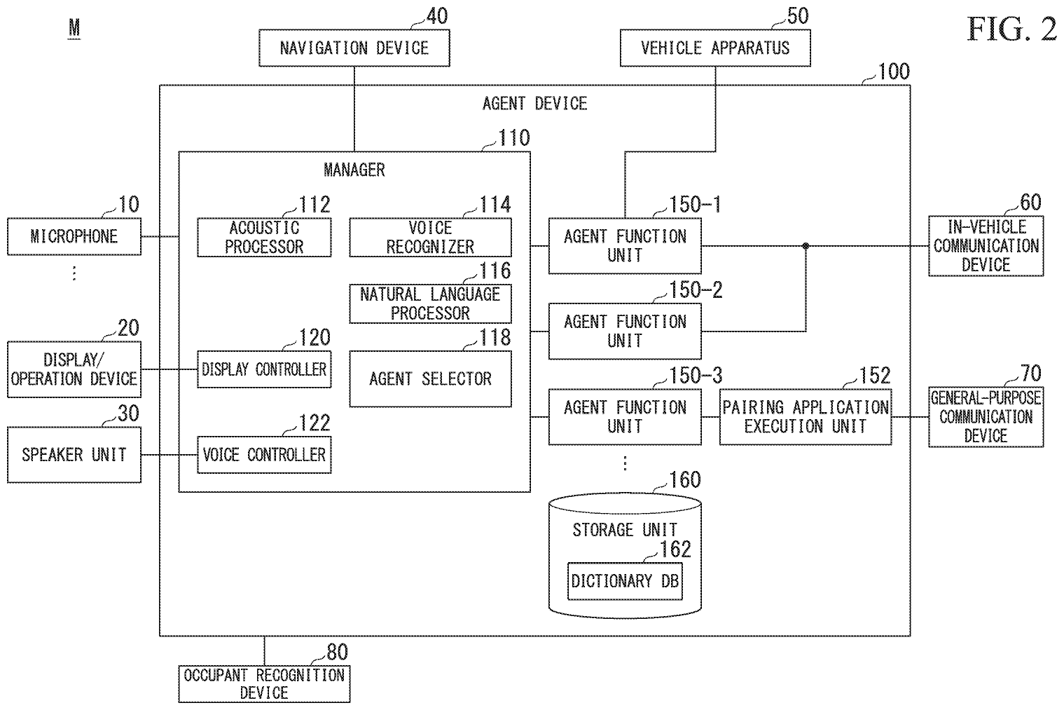

FIG. 2 is a diagram illustrating a constitution of the agent device 100 according to a first embodiment and an apparatus installed in the vehicle M. The vehicle M has, for example, at least one microphone 10, a display/operation device 20, a speaker unit 30, a navigation device 40, a vehicle apparatus 50, an in-vehicle communication device 60, an occupant recognition device 80, and the agent device 100 installed therein. A general-purpose communication device 70 such as a smartphone is brought into a vehicle interior and used as a communication device in some cases. These devices are connected to each other through a multiplex communication line such as a controller area network (CAN) communication line, a serial communication line, a wireless communication network, or the like. The constitution illustrated in FIG. 2 is merely an example and a part of the constitution may be omitted or another constitution may be added.

The microphone 10 is a sound collection unit configured to collect sound emitted inside the vehicle interior. The display/operation device 20 is a device (or a group of devices) capable of displaying an image and receiving an input operation. The display/operation device 20 includes, for example, a display device constituted as a touch panel. The display/operation device 20 may further include a head up display (HUD) or a mechanical input device. The speaker unit 30 includes, for example, a plurality of speakers (sound output units) arranged at different positions in the vehicle interior. The display/operation device 20 may be shared by the agent device 100 and the navigation device 40. Details of these will be described later.

The navigation device 40 includes a navigation human machine interface (HMI), a position positioning device such as a global positioning system (GPS), a storage device having map information stored therein, and a control device (a navigation controller) configured to perform route retrieval and the like. Some or all of the microphone 10, the display/operation device 20, and the speaker unit 30 may be used as the navigation HMI. The navigation device 40 retrieves a route (a navigation route) for moving to a destination input by the occupant from a position of the vehicle M identified using the position positioning device and outputs guidance information using the navigation HMI so that the vehicle M can travel along the route. A route retrieval function may be provided in a navigation server accessible over the network NW. In this case, the navigation device 40 acquires a route from the navigation server and outputs guidance information. The agent device 100 may be constructed using the navigation controller as a base. In this case, the navigation controller and the agent device 100 are integrally constituted in hardware.

The vehicle apparatus 50 includes, for example, a driving force output device such as an engine or a driving motor, an engine starting-up motor, a door lock device, a door opening/closing device, an air conditioner, and the like.

The in-vehicle communication device 60 is, for example, a wireless communication device which can access the network NW using a cellular network or a Wi-Fi network.

The occupant recognition device 80 includes, for example, a seating sensor, a camera in the vehicle interior, an image recognition device, and the like. The seating sensor includes a pressure sensor provided below a seat, a tension sensor attached to a seat belt, and the like. The camera in the vehicle interior is a charge coupled device (CCD) camera or a complementary metal oxide semiconductor (CMOS) camera provided in the vehicle interior. The image recognition device analyzes an image of the camera in the vehicle interior and recognizes the presence/absence of an occupant for each seat, a face direction, and the like.

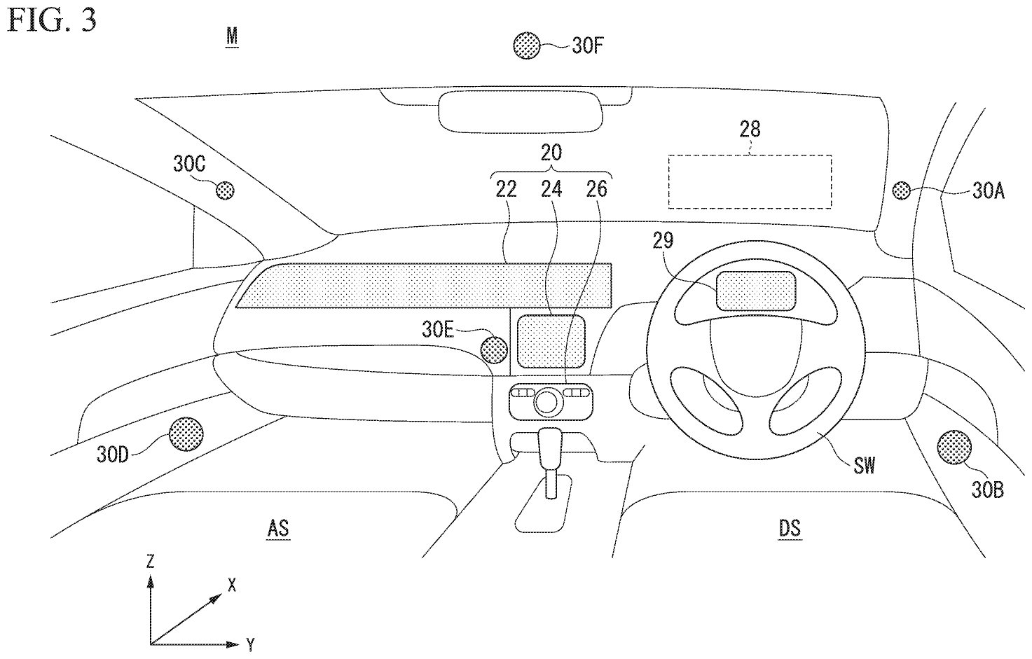

FIG. 3 is a diagram illustrating an arrangement example of the display/operation device 20 and the speaker unit 30. The display/operation device 20 includes, for example, a first display 22, a second display 24, and an operation switch ASSY26. The display/operation device 20 may further include a HUD 28. The display/operation device 20 may further include a meter display 29 provided on a portion of an instrument panel facing a driver's seat DS. A unit obtained by combining the first display 22, the second display 24, the HUD 28, and the meter display 29 is an example of a “display unit.”

The vehicle M includes, for example, the driver's seat DS in which a steering wheel SW is provided and a passenger's seat AS provided in a vehicle width direction (a Y direction in the drawings) with respect to the driver's seat DS. The first display 22 is a horizontally long display device which extends from around the middle of the instrument panel between the driver's seat DS and the passenger's seat AS to a position of the passenger's seat AS facing a left end portion. The second display 24 is installed around an intermediate portion between the driver's seat DS and the passenger's seat AS in the vehicle width direction and below the first display. For example, both of the first display 22 and the second display 24 are constituted as touch panels and include a liquid crystal display (LCD), an organic electroluminescence (EL), a plasma display, or the like as a display unit. The operation switch ASSY26 is formed by integrating dial switches, button switches, and the like. The display/operation device 20 outputs the content of an operation performed by the occupant to the agent device 100. The content displayed on the first display 22 or the second display 24 may be determined using the agent device 100.

The speaker unit 30 includes, for example, speakers 30A to 30F. The speaker 30A is installed on a window post (a so-called A pillar) on the driver's seat DS side. The speaker 30B is installed at a lower part of a door near the driver's seat DS. The speaker 30C is installed on a window post on the passenger's seat AS side. The speaker 30D is installed at a lower part of a door near the passenger seat AS. The speaker 30E is installed near the second display 24. The speaker 30F is installed in a ceiling (a roof) of the vehicle interior. The speaker unit 30 may be installed at a lower part of a door near a right rear seat or a left rear seat.

In such an arrangement, for example, when sound is exclusively output from the speakers 30A and 30B, a sound image is localized near the driver's seat DS. The expression “The sound image is localized” means, for example, determining a spatial position of a sound source felt by the occupant by adjusting the loudness of sound transmitted to the occupant's left and right ears. When sound is exclusively output from the speakers 30C and 30D, a sound image is localized near the passenger seat AS. When sound is exclusively output from the speaker 30E, a sound image is localized near the front of the vehicle interior. In addition, when sound is exclusively output from the speaker 30F, a sound image is localized near an upper part of the vehicle interior. The present invention is not limited thereto. In addition, the speaker unit 30 can localize a sound image at an arbitrary position in the vehicle interior by adjusting the distribution of sound output from each of the speakers using a mixer or an amplifier.

### [Agent Device]

Referring to FIG. 2 again, the agent device 100 includes a manager 110, agent function units 150-1, 150-2, and 150-3, and a pairing application execution unit 152. The manager 110 includes, for example, an acoustic processor 112, a voice recognizer 114, a natural language processor 116, an agent selector 118, a display controller 120, and a voice controller 122. When it is not necessary to distinguish between agent function units, the agent function units are simply referred to as an agent function unit 150 or agent function units 150 in some cases. The illustration of three agent function units 150 is merely an example illustrated to correspond to the number of agent servers 200 in FIG. 1 and the number of agent function units 150 may be two or four or more.

The software arrangement illustrated in FIG. 2 is simply shown for the sake of explanation and can be actually modified arbitrarily so that, for example, the manager 110 may be disposed between the agent function units 150 and the in-vehicle communication device 60.

Each constituent element of the agent device 100 is realized, for example, by a hardware processor such as a central processing unit (CPU) configured to execute a program (software). Some or all of these constituent elements may be implemented using hardware (a circuit unit; including a circuitry) such as a large scale integration (LSI), an application specific integrated circuit (ASIC), a field-programmable gate array (FPGA), and a graphics processing unit (GPU) or in cooperation with software and hardware. The program may be stored in advance in a storage device (a storage device including a transitory storage medium) such as a hard disk drive (HDD) or a flash memory or a removable storage medium (a transitory storage medium) such as a digital versatile disc (DVD) or a compact disc (CD)-read only memory (ROM), and the storage medium may be installed in the drive device to be installed. The acoustic processor 112 is an example of a “voice receiver.” The combination of the voice recognizer 114 and the natural language processor 116 is an example of a “recognizer.”

The agent device 100 includes a storage unit 160. The storage unit 160 is realized using various storage devices described above. The storage unit 160 stores, for example, data and programs such as a dictionary database (DB) 162.

The manager 110 functions using a program such as an operating system (OS) or middleware to be executed.

The acoustic processor 112 in the manager 110 receives sound collected from the microphone 10 and performs acoustic processing on the received sound so that the received sound is in an appropriate state in which the voice recognizer 114 can recognize sound. The acoustic processing is, for example, noise removal using filtering such as a band-pass filter, amplification of sound, or the like.

The voice recognizer 114 recognizes the meaning of a voice (a voice stream) from the voice which has been subjected to the acoustic processing. First, the voice recognizer 114 detects a voice section on the basis of an amplitude and a zero crossing of a voice waveform in a voice stream. The voice recognizer 114 may perform section detection based on voice identification and non-voice identification in frame units based on a Gaussian mixture model (GMM). Subsequently, the voice recognizer 114 converts a voice in the detected voice section into text and outputs character information which has been converted into text to the natural language processor 116.

The natural language processor 116 performs semantic interpretation on character information input from the voice recognizer 114 with reference to the dictionary DB 162. The dictionary DB 162 is obtained by associating abstracted semantic information with character information. The dictionary DB 162 may include list information of synonyms and similar words. Stages of a process of the voice recognizer 114 and a process of the natural language processor 116 are not clearly divided and the processes may be performed while interacting with each other like the fact that the processing result of the natural language processor 116 is received and the voice recognizer 114 corrects the recognition result or the like.

For example, when the meaning (a request) such as “What is the weather today” or “What is the weather” has been recognized as a recognition result, the natural language processor 116 may generate a command obtained by replacing “What is the weather today” or “What is the weather” with standard character information of “the weather today.” The command is, for example, a command for executing a function included in each of the agent function units 150-1 to 150-3. Thus, even when a voice of a request has character fluctuations, it is possible to easily perform the requested dialog. The natural language processor 116 may recognize the meaning of the character information, for example, using artificial intelligence processing such as machine learning processing using probability or may generate a command based on the recognition result. When formats and parameters of commands for executing functions are different in the agent function units 150, the natural language processor 116 may generate a recognizable command for each agent function unit 150.

The natural language processor 116 outputs the generated command to the agent function units 150-1 to 150-3. The voice recognizer 114 may output a voice stream to agent function units in which an input of a voice stream is required among the agent function units 150-1 to 150-3, in addition to a voice command.

Each of the agent function units 150 controls the agent in cooperation with the corresponding agent server 200 and provides a service including a voice response in accordance with the utterance of the occupant of the vehicle. The agent function units 150 may include an agent function unit to which an authority to control the vehicle apparatus 50 has been given. The agent function units 150 may communicate with the agent servers 200 in cooperation with the general-purpose communication device 70 via the pairing application execution unit 152. For example, an authority to control the vehicle apparatus 50 is given to the agent function unit 150-1. The agent function unit 150-1 communicates with the agent server 200-1 via the in-vehicle communication device 60. The agent function unit 150-2 communicates with the agent server 200-2 via the in-vehicle communication device 60. The agent function unit 150-3 communicates with the agent server 200-3 in cooperation with the general-purpose communication device 70 via the pairing application execution unit 152.

The pairing application execution unit 152 performs pairing with the general-purpose communication device 70, for example, using Bluetooth (registered trademark) and connects the agent function unit 150-3 to the general-purpose communication device 70. The agent function unit 150-3 may be connected to the general-purpose communication device 70 through wired communication using a universal serial bus (USB) or the like. Hereinafter, an agent which appears using the agent function unit 150-1 and the agent server 200-1 in cooperation with each other may be referred to as an agent 1, an agent which appears using the agent function unit 150-2 and the agent server 200-2 in cooperation with each other may be referred to as an agent 2, and an agent which appears using the agent function unit 150-3 and the agent server 200-3 in cooperation with each other may be referred to as an agent 3 in some cases. Each of the agent function units 150-1 to 150-3 processes a process based on a voice command input from the manager 110 and outputs the execution result to the manager 110.

The agent selector 118 selects an agent function configured to providing a response to the occupant's utterance among the plurality of agent function units 150-1 to 150-3 on the basis of a response result obtained from each of the plurality of agent function units 150-1 to 150-3 to the command. Details of the function of the agent selector 118 will be described later.

The display controller 120 causes an image to be displayed on at least a part of the display unit in response to an instruction from the agent selector 118 or each of the agent function units 150. A description will be provided below assuming that an image related to the agent is displayed on the first display 22. Under the control of the agent selector 118 or the agent function units 150, the display controller 120 generates, for example, an image of an anthropomorphic agent (hereinafter referred to as an “agent image”) which communicates with the occupant in the vehicle interior and causes the generated agent image to be displayed on the first display 22. The agent image is, for example, an image in the form in which the agent image talks to the occupant. The agent image may include, for example, at least a face image in which a facial expression and a face direction are recognized by a viewer (the occupant). For example, in the agent image, parts imitating eyes and a nose are represented in a face region and the facial expression and the face direction may be recognized on the basis of positions of the parts in the face region. The agent image may be perceived three-dimensionally, the viewer may recognize the face direction of the agent is recognized by including a head image in a three-dimensional space, and an operation, a behavior, a posture, and the like of the agent may be recognized by including an image of a main body (a torso and limbs). The agent image may be an animation image. For example, the display controller 120 causes the agent image to be displayed on a display region near the position of the occupant recognized by the occupant recognition device 80 or may generate and display the agent image having a face directed to the position of the occupant.

The voice controller 122 causes a voice to be output to some or all of the speakers included in the speaker unit 30 in accordance with an instruction from the agent selector 118 or the agent function units 150. The voice controller 122 may perform control so that a sound image of an agent voice is localized at a position corresponding to a display position of the agent image using a plurality of the speaker units 30. The position corresponding to the display position of the agent image is, for example, a position in which it is expected that the occupant feels that the agent image is speaking the agent voice. To be specific, the position is a position near the display position of the agent image (for example, within 2 to 3 [cm]).

### [Agent Server]

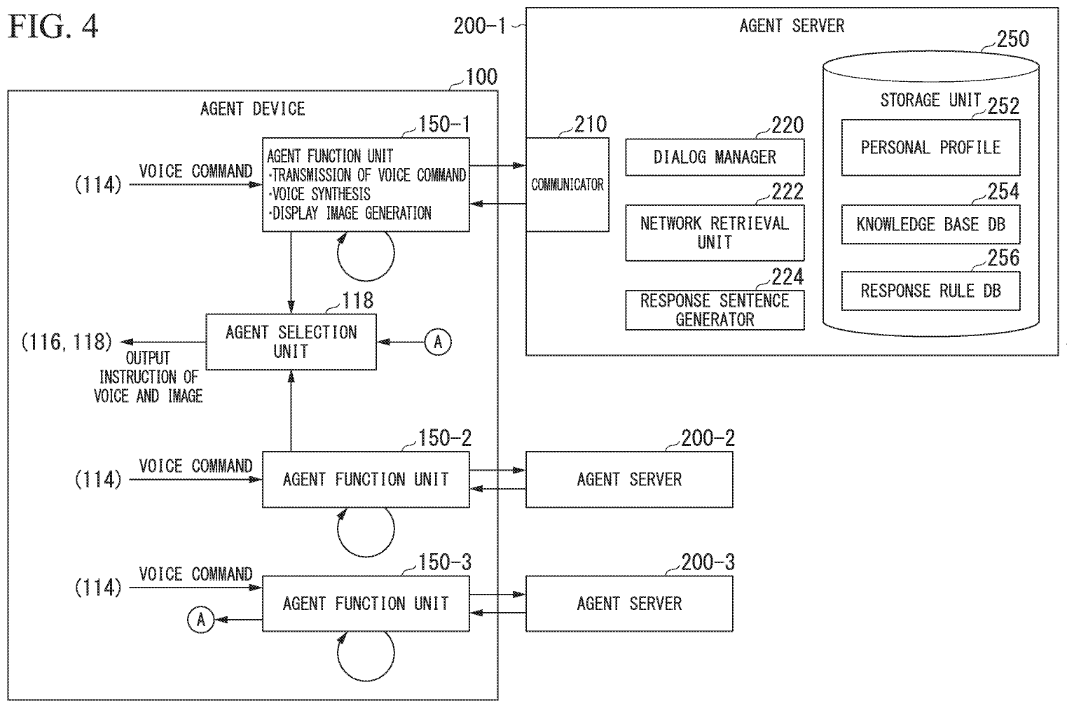

FIG. 4 is a diagram illustrating a constitution of each of the agent servers 200 and a part of a constitution of the agent device 100. The constitution of the agent server 200 and an operation of each of the agent function units 150 and the like will be described below. Here, a description of physical communication from the agent device 100 to the network NW will be omitted. Although a description will be provided below by mainly focusing on the agent function unit 150-1 and the agent server 200-1, although detailed functions of other sets of agent function units and agent servers may be different, the other sets perform substantially the same operations.

The agent server 200-1 includes a communicator 210. The communicator 210 is, for example, a network interface such as a network interface card (NIC). Furthermore, the agent server 200-1 includes, for example, a dialog manager 220, a network retrieval unit 222, and a response sentence generator 224. These constituent elements are implemented, for example, using a hardware processor such as a CPU executed through a program (software). Some or all of these constituent elements may be implemented using hardware (a circuit unit; including a circuitry) such as an LSI, an ASIC, an FPGA, and a GPU or may be implemented using software and hardware in cooperation with each other. The program may be stored in advance in a storage device (a storage device including a transitory storage medium) such as an HDD or a flash memory or may be stored in a removable storage medium (a transitory storage medium) such as a DVD or a CD-ROM, and the storage medium may be installed in the form of being mounted on the drive device.

Each of the agent servers 200 includes the storage unit 250. The storage unit 250 is realized using various storage devices described above. The storage unit 250 stores, for example, data and programs such as a personal profile 252, a knowledge base DB 254, and a response rule DB 256.

In the agent device 100, the agent function unit 150-1 transmits a command (or a command which has been subjected to processing such as compression or encoding) to the agent server 200-1. The agent function unit 150-1 may execute processing requested through a command when a command in which local processing (processing with no intervention of the agent server 200-1) is possible is recognized. The command in which local processing is possible is, for example, a command which can be answered with reference to the storage unit 160 included in the agent device 100. To be more specific, the command in which local processing is possible may be, for example, a command in which a specific person's name is retrieved from a telephone directory and calling of a telephone number associated with the matching name is performed (calling of the other party is performed). Therefore, the agent function unit 150-1 may have some of the functions of the agent server 200-1.

The dialog manager 220 determines the content of a response to the occupant of the vehicle M (for example, the content of an utterance to the occupant and an image to be output) on the basis of the input command with reference to the personal profile 252, the knowledge base DB 254, the response rule DB 256. The personal profile 252 includes individual information, hobbies and preferences, a past conversation history, and the like of the occupant stored for each occupant. The knowledge base DB 254 includes information in which relationships between things are defined. The response rule DB 256 includes information in which operations to be performed by the agent with respect to commands (such as answers and the details of apparatus control) are defined.

The dialog manager 220 may identify the occupant by performing collating with the personal profile 252 using feature information obtained from a voice stream. In this case, in the personal profile 252, for example, individual information is associated with voice feature information. The voice feature information includes, for example, information about characteristics of a speaking style such as a sound pitch, an intonation, and a rhythm (a pattern of sound tones) and a feature amount using a Mel Frequency Cepstrum Coefficient or the like. The voice feature information includes, for example, information obtained by causing the occupant to utter a predetermined word or sentence during an initial registration of the occupant and recognizing the uttered voice.

When a command is related to requesting of information in which retrieval is possible over the network NW, the dialog manager 220 causes the network retrieval unit 222 to perform retrieval. The network retrieval unit 222 accesses various web servers 300 over the network NW and acquires desired information. The “information in which retrieval is possible over the network NW” is, for example, an evaluation result of a general user of a restaurant near the vehicle M or a weather forecast according to a position of the vehicle M on that day.

The response sentence generator 224 generates a response sentence so that the content of the utterance determined by the dialog manager 220 is transmitted to the occupant of the vehicle M and transmits the generated response sentence to the agent device 100. The response sentence generator 224 may acquire the recognition result of the occupant recognition device 80 from the agent device 100 and may call the occupant's name or generate a response sentence in a speaking manner similar to that of the occupant when it is identified that the occupant who has performed an utterance including a command using the obtained recognition result is an occupant registered in the personal profile 252.

The agent function unit 150 instructs the voice controller 122 to perform voice synthesis and output a voice if acquiring a response sentence. The agent function unit 150 instructs the display controller 120 to display the agent image in accordance with the voice output. Thus, an agent function in which an agent which virtually appears responds to the occupant of the vehicle M is realized.

### [Agent Selector]

A function of the agent selector 118 will be described in detail below. The agent selector 118 selects an agent function unit which responds to occupants' utterances on the basis of predetermined conditions with respect to the results of the response made by each of the plurality of agent function units 150-1 to 150-3 to the command. A description will be provided below assuming that the response results are obtained from all of the plurality of agent function units 150-1 to 150-3. When there is an agent function unit for which a response result is not obtained or an agent function unit having no function corresponding to a command, the agent selector 118 may exclude the agent function units from selection targets.

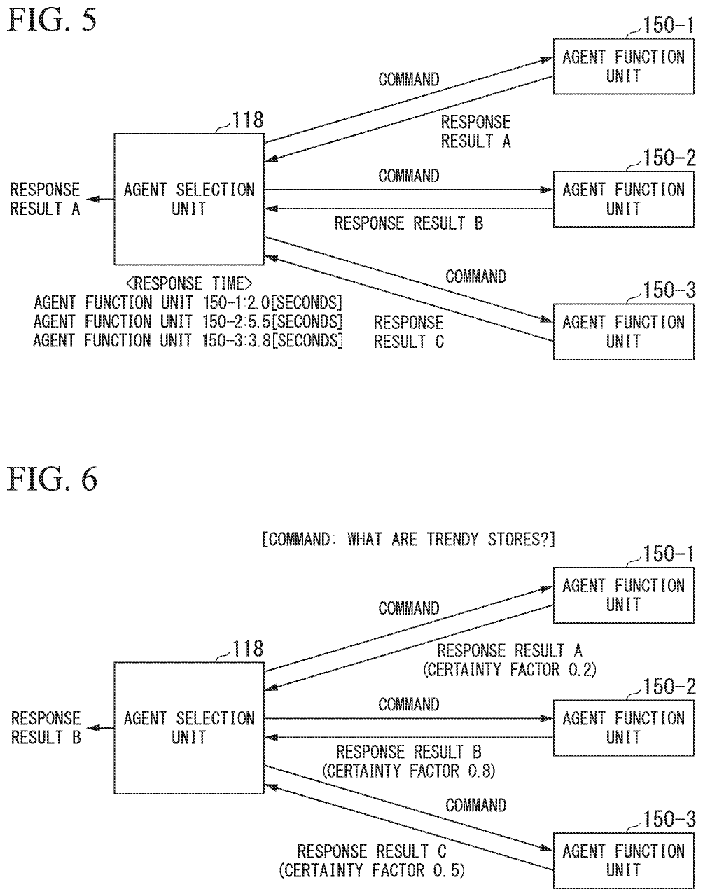

For example, the agent selector 118 selects an agent function unit which responds to the occupant's utterance among the plurality of agent function units 150-1 to 150-3 on the basis of a response speed of the plurality of agent function units 150-1 to 150-3. FIG. 5 is a diagram for explaining a process of the agent selector 118. The agent selector 118 measures a time from a time at which a command is output using the natural language processor 116 to a time at which a response result is obtained for each of the agent function units 150-1 to 150-3 (hereinafter referred to as a “response time”). Furthermore, the agent selector 118 selects an agent function unit having the shortest time among the response times as the agent function time which responds to the occupant's utterance. The agent selector 118 may select a plurality of agent function units whose response time is shorter than a predetermined time as an agent function unit which responds.

In the example of FIG. 5, when the agent function units 150-1 to 150-3 output the results A to C as a response to the command to the agent selector 118, it is assumed that response times are 2.0 [seconds], 5.5 [seconds], and 3.8 [seconds]. In this case, the agent selector 118 preferentially selects the agent function unit 150-1 (the agent 1) having the shortest response time as the agent which will respond to the occupant's utterance. This preferential selection is only a response result of one agent function unit (a response result A in the example of FIG. 5) being selected when a plurality of response results A to C are output, and causing the contents of the response result A to be output in a highlighted manner compared to other response results. Outputting in a highlighted manner means, for example, displaying characters of the response result in a large size, changing a color, increasing a sound volume, or setting a display order or an output order to being first. In this way, when the agent is selected on the basis of the response speed (that is, the shortness of the response speed), it is possible to provide a response to an utterance to the occupant in a short time.

The agent selector 118 may select an agent function unit which responds to the occupant's utterance on the basis of the certainty factor of the response results A to C instead of (or in addition to) the response time described above. FIG. 6 is a diagram for explaining selection of an agent function unit on the basis of the certainty factor of a response result. The certainty factor is, for example, a degree (an index value) at which a result of a response to a command is estimated to be a correct answer. The certainty factor is a degree at which a response to the occupant's utterance is estimated to meet the occupant's request or to be an answer expected by the occupant. Each of the plurality of agent function units 150-1 to 150-3 determines the content of the response and the certainty factor for the content of the response on the basis of, for example, the personal profile 252, the knowledge base DB 254, and the response rule DB 256 provided in each of the storage units 250.

For example, when the dialog manager 220 receives a command “What is the most popular store?” from the occupant, it can be assumed that information of a “clothes store,” a “shoe store,” and an “Italian restaurant store” is acquired from various web servers 300 as information corresponding to the command through the network retrieval unit 222. Here, the dialog manager 220 sets a certainty factor when there is a high degree of matching with the occupant's hobby to have a high certainty factor for the content of the response with reference to the personal profile 252. For example, when the occupant's hobby is “dining,” the dialog manager 220 sets the certainty factor of an “Italian restaurant store” to have a degree higher than that of other information. The dialog manager 220 may set the certainty factor to have a high degree when an evaluation result (a recommended degree) of the general user for each store acquired from the various web servers 300 is high.

The dialog manager 220 may determine the certainty factor on the basis of the number of response candidates obtained as retrieval results with respect to a command. For example, when the number of response candidate is one, the dialog manager 220 sets the certainty factor to have the highest degree because there are no other candidates. The dialog manager 220 performs setting so that the greater the number of response candidates, the lower the certainty factor.

The dialog manager 220 may determine the certainty factor on the basis of a fulfillment level of the content of the response obtained as a retrieval result with respect to a command. For example, when not only character information but also image information can be obtained as retrieval results, the dialog manager 220 sets the certainty factor to have a high degree because the fulfillment level thereof is higher than that of a case in which an image is not obtained.

The dialog manager 220 may set the certainty factor on the basis of a relationship between the command and information on the content of the response with reference to the knowledge base DB 254 using the command and information on the content of the response. The dialog manager 220 may refer to the personal profile 252, refer to whether there is a similar question in the history of recent (for example, within one month) dialogs, and set the certainty factor for the content of a response similar to the answer to have a high degree when there is a similar question. A history of the dialog may be a history of a dialog with the occupant who uttered or a history of a dialog included in the personal profile 252 other than the occupant. The dialog manager 220 may set the certainty factor by combining setting conditions of a plurality of the certainty factors described above.

The dialog manager 220 may normalize the certainty factor. For example, the dialog manager 220 may perform normalization so that the certainty factor ranges from 0 to 1 for each of the above-described setting conditions. Thus, even when the comparison is performed using the certainty factors set by a plurality of setting conditions, the quantification is uniformly performed. Therefore, the certainty factor of only one of the setting conditions does not increase. As a result, it is possible to select a more appropriate response result on the basis of the certainty factor.

In the example of FIG. 6, when the certainty factor of the response result A is 0.2, the certainty factor of the response result B is 0.8, and the certainty factor of the response result C is 0.5, the agent selector 118 selects the agent 2 corresponding to the agent function unit 150-2 which has output the response result B having the highest certainty factor as an agent which responds to the occupant's utterance. The agent selector 118 may select a plurality of agents which have output a response result having a certainty factor equal to or more than a threshold value as an agent which responds to an utterance. Thus, an agent appropriate for the occupant's request can be made to respond.

The agent selector 118 may compare the response results A to C of the agent function units 150-1 to 150-3 and select the agent function units 150 which have output a large number of the same response contents as an agent function unit (an agent) which will respond to the occupant's utterance. The agent selector 118 may select a predetermined specific agent function unit among a plurality of agent function units which have output the same content of the response or select an agent function unit having the fastest response time. Thus, it is possible to output a response obtained using majority decision from the results of the plurality of responses to the occupant and to improve the reliability of the results of the responses.

In addition to the above method for selecting the agent, the agent selector 118 may cause the first display 22 to display information on a plurality of agents which have responded to the command and select an agent which responds on the basis of an instruction from the occupant. Examples of scenes in which the occupant selects an agent include a case in which there are a plurality of agents having the same response time and certainty factor and a case in which the setting to select an agent has been performed in advance using an instruction of the occupant.

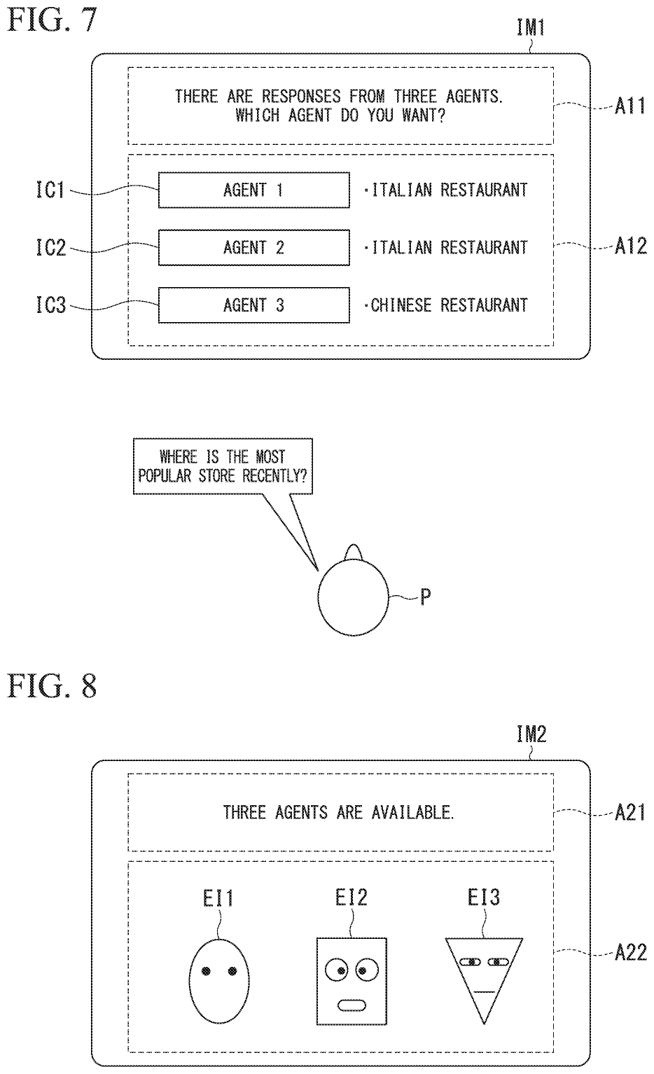

FIG. 7 is a diagram illustrating an example of an image IM1 displayed on the first display 22 as an agent selection screen. The contents, a layout, and the like displayed in the image IM1 are not limited thereto. The image IM1 is generated using the display controller 120 on the basis of information from the agent selector 118. The same applies to the following description of the image.

The image IM1 includes, for example, a character information display region A11 and a selection item display region A12. In the character information display region A11, for example, the number of agents having the result of a response to an occupant P's utterance and information used for prompting the occupant P to select an agent are displayed. For example, when the occupant P utters “Where are the currently most popular stores?,” the agent function units 150-1 to 150-3 acquire the results of the responses to the command obtained from the utterance and output the results to the agent selector 118. The display controller 120 receives an instruction to display an agent selection screen from the agent selector 118, generates the image IM1, and causes the first display 22 to display the generated image on the image IM1. In the example of FIG. 7, in the character information display region A11, character information such as “There have been responses from three agents. Which agent do you want to use?” is displayed.

In the selection item display region A12, for example, an icon IC configured for selecting an agent is displayed. In the selection item display region A12, at least a part of the results of each of the agent's responses may be displayed. In the selection item display region A12, information on the above response time and certainty factor may be displayed.

In the example of FIG. 7, in the selection item display region A12, graphical user interface (GUI) switches IC1 to IC3 corresponding to the agent function units 150-1 to 150-3 and a brief description of the response results (for example, a genre of a store) are displayed. When the GUI switches IC1 to IC3 are displayed on the basis of an instruction from the agent selector 118, the display controller 120 may display the agents side by side in the order of decreasing response time (in the order of increasing response speed) or in the order of the certainty factor of the response result.

When the selection of any one GUI switch among the GUI switch IC1 to IC3 through an operation of the occupant P performed on the first display 22 is received, the agent selector 118 selects an agent associated with the selected GUI switch IC as an agent which responds to the occupant's utterance and causes the agent to respond. Thus, a response can be provided by an agent designated by the occupant.

Here, the display controller 120 may display the agent images EI1 to EI3 corresponding to the agents 1 to 3, instead of displaying the GUI switches IC1 to IC3 described above. The agent image displayed on the first display 22 will be described below for each scene.

FIG. 8 is a diagram illustrating an example of the image IM2 displayed using the display controller 120 in a scene before the occupant utters. The image IM2 includes, for example, the character information display region A21 and an agent display region A22. In the character information display region A21, for example, information on the number of and types of available agents is displayed. An available agent is, for example, an agent which can respond to the occupant's utterance. The available agent is set on the basis of, for example, a region in which the vehicle M is traveling, a time period, a state of an agent, and the occupant P recognized using the occupant recognition device 80. The state of the agent includes, for example, a state in which the vehicle M cannot communicate with the agent server 200 because the vehicle M is underground or in a tunnel or a state in which processing through another command is already being executed and processing for a next command cannot be executed. In the example of FIG. 8, in the character information display region A21, character information such as “Three agents are available” is displayed.

The agent display region A22 displays an agent image associated with the available agent. In the example of FIG. 8, the agent images EI1 to EI3 associated with the agents 1 to 3 are displayed in the agent display region A22. Thus, the occupant can intuitively grasp the number of available agents.

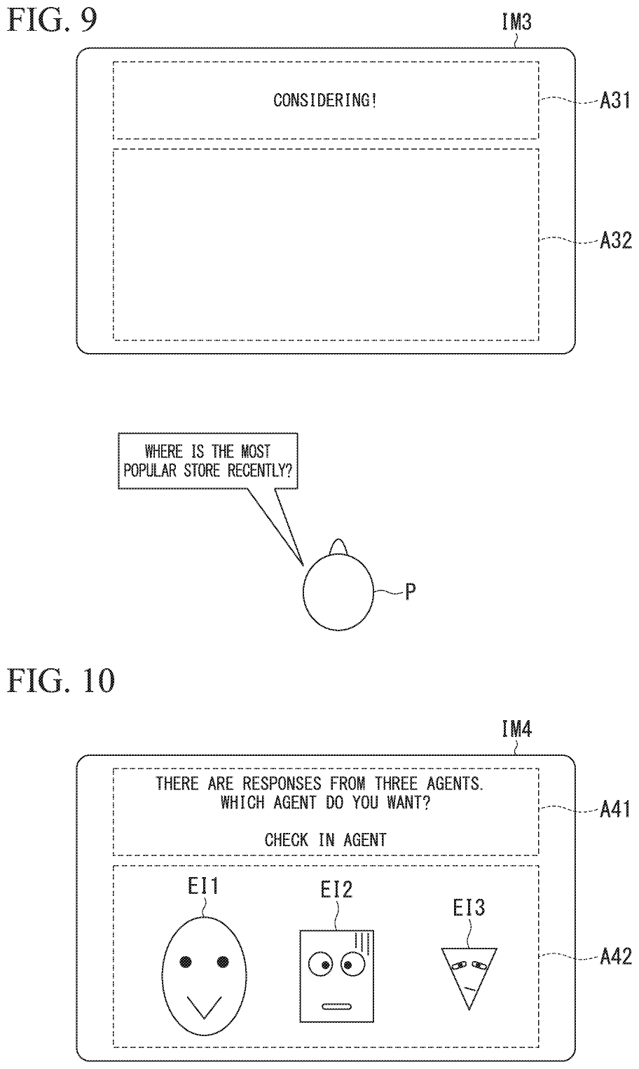

FIG. 9 is a diagram illustrating an example of an image IM3 displayed using the display controller 120 in a scene in which the occupant provides an utterance including a command FIG. 9 illustrates an example in which the occupant P makes an utterance of “Where is the most popular store?” The image IM3 includes, for example, a character information display region A31 and an agent display region A32. In the character information display region A31, for example, information indicating the state of the agent is displayed. In the example of FIG. 9, in the character information display region A21, character information of “Working!” indicating that the agent is executing a process is displayed.

The display controller 120 performs control in which the agent images EI1 to EI3 are deleted from the agent display region A22 until each of the agents 1 to 3 starts processing related to the utterance content and then the result of the response to the utterance is obtained. Thus, this allows the occupant to intuitively recognize that the agent is processing. The display controller 120 may make a display mode of the agent images EI1 to EI3 different from a display mode before the occupant P utters, instead of deleting the agent images EI1 to EI3. In this case, for example, the display controller 120 changes the facial expression of the agent images EI1 to EI3 to “thinking facial expression” or “worried facial expression” or displays an agent image which performs an operation indicating that a process is being executed (for example, an operation of opening a dictionary and turning a page or an operation of performing a retrieval using a terminal device).

FIG. 10 is a diagram illustrating an example of an image IM4 displayed using the display controller 120 in a scene in which an agent is selected. The image IM4 includes, for example, a character information display region A41 and an agent selection region A42. In the character information display region A41, for example, the number of agents having a result of a response to the occupant P's utterance, information used for prompting the occupant P to select an agent, and a method for selecting an agent are displayed. In the example of FIG. 10, in the character information display region A41, character information such as “There are responses from three agents. Which agent do you want?” and “Please touch an agent.” is displayed.

In the agent selection region A42, for example, the agent images EI1 to EI3 corresponding to the agents 1 to 3 in which there are the results of responses to the occupant P's utterance are displayed. When the agent images EI1 to EI3 are displayed, the display controller 120 may change a display mode of the agent image EI on the basis of the response time and the certainty factor of the result of the response described above. The display mode of the agent image in this scene is, for example, the facial expression, a size, a color, and the like of the agent image. For example, the display controller 120 generates an agent image of a smiling face when the certainty factor of the result of the response is equal to or more than a threshold value, and generates an agent image of a troubled facial expression or a sad facial expression when the certainty factor is less than a threshold value. The display controller 120 may control the display mode such that the agent image enlarges when the certainty factor increases. In this way, when the display mode of the agent image is changed in accordance with the result of the response, the occupant P can intuitively grasp a degree of confidence and the like of the result of the response for each agent and this can be used as one indicator for selecting an agent.

When the selection of any one agent image among the agent images EI1 to EI3 through an operation of the occupant P performed on the first display 22 is received, the agent selector 118 selects an agent associated with the selected agent image EI as an agent which responds to the occupant's utterance and causes the agent to respond.

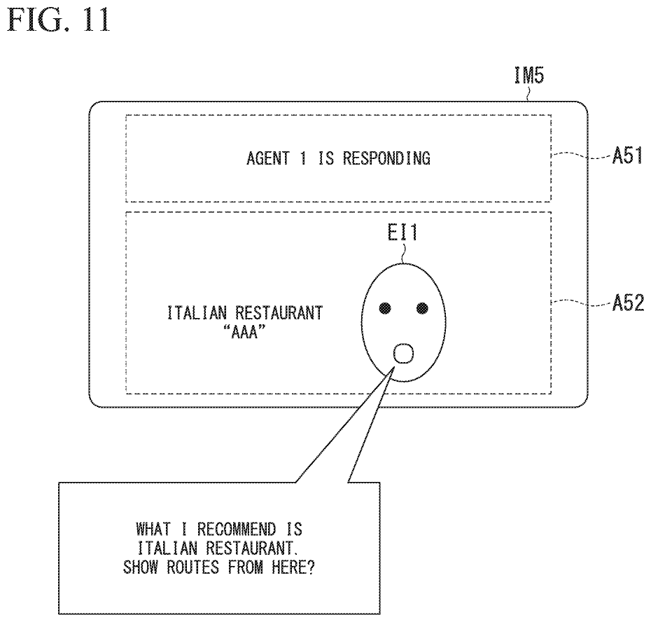

FIG. 11 is a diagram illustrating an example of an image IM5 displayed using the display controller 120 in scene after the agent image EI1 has been selected. The image IM5 includes, for example, a character information display region A51 and an agent display region A52. Information on the agent 1 which has responded is displayed in the character information display region A51. In the example of FIG. 11, character information “the agent 1 is responding” is displayed in the character information display region A51. In a scene in which the agent image EI1 has been selected, the display controller 120 may perform control so that character information is not displayed in the character information display region A51.

In the agent display region A52, the selected agent image and the result of the response of the agent 1 are displayed. In the example of FIG. 11, the agent image EI1 and the agent result “Italian restaurant ‘AAA” are displayed in the agent display region A52. In this scene, the voice controller 122 performs a sound image localization process of localizing a voice of the result of the response provided through the agent function unit 150-1 near a position in which the agent image EI1 is positioned. In the example of FIG. 11, the voice controller 122 outputs a voice of “I recommend the Italian restaurant AAA” and “Do you want to display the route from here?”. The display controller 120 may generate and display an animated image or the like which allows the occupant P to visually recognize the agent image EI1 as if the agent image EI1 were talking in accordance with the voice output.

The agent selector 118 may cause the voice controller 122 to generate the same voice as that of the information displayed in the display region in FIGS. 7 to 11 described above and to output the generated voice from the speaker unit 30. When a voice designating an agent is received from the microphone 10 by the occupant P, the agent selector 118 selects the agent function unit 150 associated with the received agent as an agent function unit which responds to the occupant P's utterance. Thus, even when the occupant P cannot see the first display 22 because the vehicle is being driven, it is possible to identify the agent using a voice.

The agent selected by the agent selector 118 responds to the occupant P's utterance until a series of dialogs is completed. A series of dialogs ending, includes, for example, in a case in which there has been no response (for example, an utterance) from the occupant P after a predetermined time has elapsed after the response result has been output, a case in which an utterance different from that of the information on the response result is input, or a case in which the agent function is completed through the occupant P's operation. That is to say, when an utterance related to the result of the output response is provided, the agent selected by the agent selector 118 responds continuously. In the example of FIG. 11, when the occupant P utters “Display the route” after the voice of “Do you want to display the route from here?” has been output, the agent 1 causes the display controller 120 to display information on the route.

### [Processing Flow]

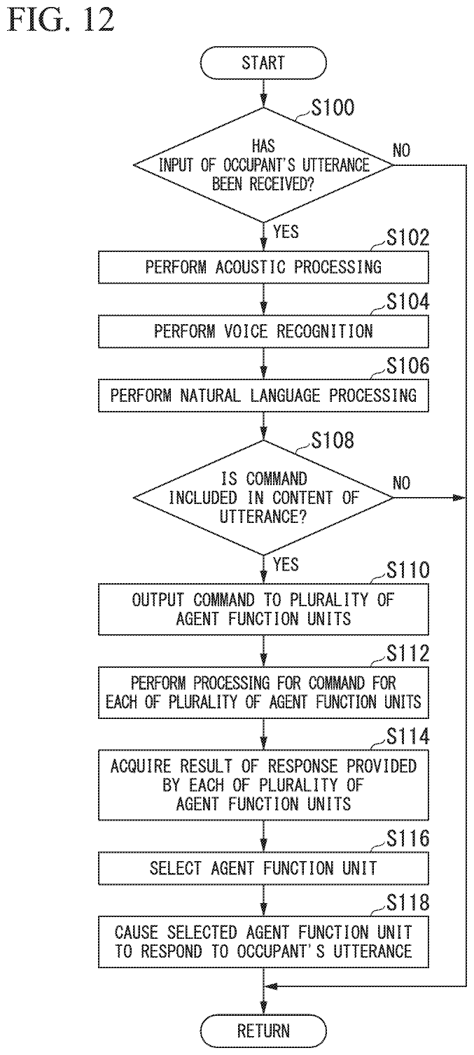

FIG. 12 is a flowchart for describing an example of a flow of a process performed through the agent device 100 in the first embodiment. The process of this flowchart may be repeatedly performed, for example, at a predetermined cycle or a predetermined timing.

First, the acoustic processor 112 determines whether an input of an occupant's utterance has been received from the microphone 10 (Step S100). When it is determined that an input of the occupant's utterance has been received, the acoustic processor 112 performs acoustic processing on a voice of the occupant's utterance (Step S102). Subsequently, the voice recognizer 114 recognizes the voice (a voice stream) which has been subjected to the acoustic processing and converts the voice into text (Step S104). Subsequently, the natural language processor 116 performs natural language processing on the character information which has been subjected to text and performs semantic analysis of the character information (Step S106).

Subsequently, the natural language processor 116 determines whether the content of the occupant's utterance obtained through the semantic analysis includes a command (Step S108). When it is determined that the command is included, the natural language processor 116 outputs the command to the plurality of agent function units 150 (Step S110). Subsequently, the plurality of agent function units performs processing for the command for each agent function unit (Step S112).

Subsequently, the agent selector 118 acquires the result of the response provided by each of the plurality of agent function units (Step S114) and selects an agent function unit on the basis of the acquired result of the response (Step S116). Subsequently, the agent selector 118 causes the selected agent function unit to respond to the occupant's utterance (Step S118). Thus, the processing of this flowchart ends. When the input of the occupant's utterance is not received in the process of Step S100 or when the content of the utterance does not include the command in the process of Step S108, the process of this flowchart ends.

According to the agent device 100 in the first embodiment described above, the plurality of agent function units 150 configured to provide the service including the voice response in accordance with the utterance of the occupant of the vehicle M, the recognizer (the voice recognizer 114 or the natural language processor 116) configured to recognize the voice command included in the occupant's utterance, and the agent selector 118 configured to output the voice command recognized by the recognizer to the plurality of agent function units 150 and select the agent function unit which responds to the occupant's utterance among the plurality of agent function units 150 on the basis of the result provided through each of the plurality of agent function units 150 are included. Thus, it is possible to provide more appropriate response results.

According to the agent device 100 related to the first embodiment, even when the occupant forgets how to start-up the agent (for example, a wake-up word which will be described later), even when the characteristics for each agent are not grasped, or even when a request in which the agent cannot be identified is performed, it is possible to cause a plurality of agents to perform a process for the utterance and to cause an agent having a more appropriate response result to respond to the occupant.

### Modified Example

In the above first embodiment, the voice recognizer 114 may recognize the wake-up word included in the voice which has been subjected to the acoustic processing, in addition to the above-described processing. The wake-up word is, for example, a word assigned to call (start-up) an agent. In the wake-up word, different words are set for agents. When the voice recognizer 114 recognizes a wake-up word used for identifying an individual agent, the agent selector 118 causes an agent assigned to the wake-up word among the plurality of agent function units 150-1 to 150-3 to respond. Thus, when the wake-up word is recognized, it is possible to select the agent function unit immediately and to provide the result of the response through the agent designated by the occupant to the occupant.

When a wake-up word (a group wake-up word) for calling a plurality of agents is recognized in advance, the voice recognizer 114 may start-up the plurality of agents associated with the group wake-up word and causes the plurality of agents to perform the above-described processing.

### Second Embodiment

A second embodiment will be described below. An agent device in the second embodiment and the agent device in the first embodiment differ in that, in the agent device in the second embodiment, an agent function unit or an agent server has a function related to voice recognition integrally performed by a manager 110. Therefore, it is assumed that a description will be provided below by mainly focusing on the above-described differences. In the following description, constituent elements that are the same as those of the above first embodiment will be the same names or reference numerals. Here, a specific description thereof will be omitted.

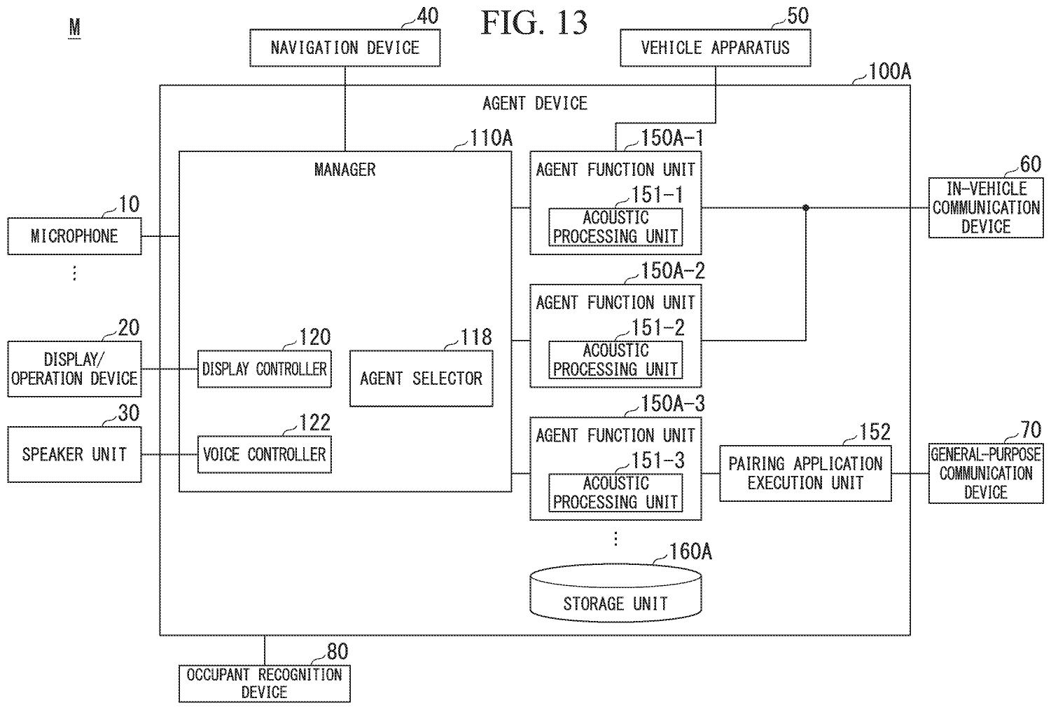

FIG. 13 is a diagram illustrating a constitution of an agent device 100A according to the second embodiment and an apparatus installed in the vehicle M. The vehicle M includes, for example, at least one microphone 10, a display/operation device 20, a speaker unit 30, a navigation device 40, a vehicle apparatus 50, an in-vehicle communication device 60, an occupant recognition device 80, and the agent device 100A installed therein. There is a case in which a general-purpose communication device 70 is brought into a vehicle interior and used as a communication device. These devices are connected to each other using a multiplex communication line such as a CAN communication line, a serial communication line, a wireless communication network, or the like.

The agent device 100A includes a manager 110A, agent function units 150A-1, 150A-2, and 150A-3, and a pairing application execution unit 152. The manager 110A includes, for example, an agent selector 118, a display controller 120, and a voice controller 122. Each constituent element in the agent device 100A is realized, for example, using a hardware process such as a CPU configured to execute a program (software). Some or all of these constituent elements may be implemented using hardware (including a circuit unit; including a circuitry) such as an LSI, an ASIC, an FPGA, and a GPU or realized using software and hardware in cooperation with each other. The program may be stored in a storage device such as an HDD or a flash memory (a storage device including a transitory storage medium) in advance or stored in a removable storage medium (a transitory storage medium) such as a DVD or a CD-ROM and may be installed when a storage medium is attached to a drive device. The acoustic processor 151 in the second embodiment is an example of a “voice receiver.”

The agent device 100A includes a storage unit 160A. The storage unit 160A is implemented using the various storage device described above. The storage unit 160A stores, for example, various data and programs.

The agent device 100A includes, for example, a multi-core processor and one core processor (an example of a processor) implements one agent function unit. Each of the agent function units 150A-1 to 150A-3 functions when a program such as an OS or middleware is executed using a core processor or the like. In the second embodiment, each of the plurality of microphones 10 is assigned to one of the agent function unit 150A-1 to the agent function unit 150A-3. In this case, each of the microphones 10 may be incorporated in each of the agent function units 150A-1 to 150A-3.

The agent function units 150A-1 to 150A-3 include acoustic processors 151-1 to 151-3. The acoustic processors 151-1 to 151-3 perform acoustic processing on a voice input from the microphones 10 assigned to each of the acoustic processors 151-1 to 151-3. The acoustic processors 151-1 to 151-3 perform acoustic processes associated with the agent function units 150A-1 to 150A-3. The acoustic processors 151-1 to 151-3 output the voice (the voice stream) which has been subjected to acoustic processing to agent servers 200A-1 to 200A-3 associated with agent function units.

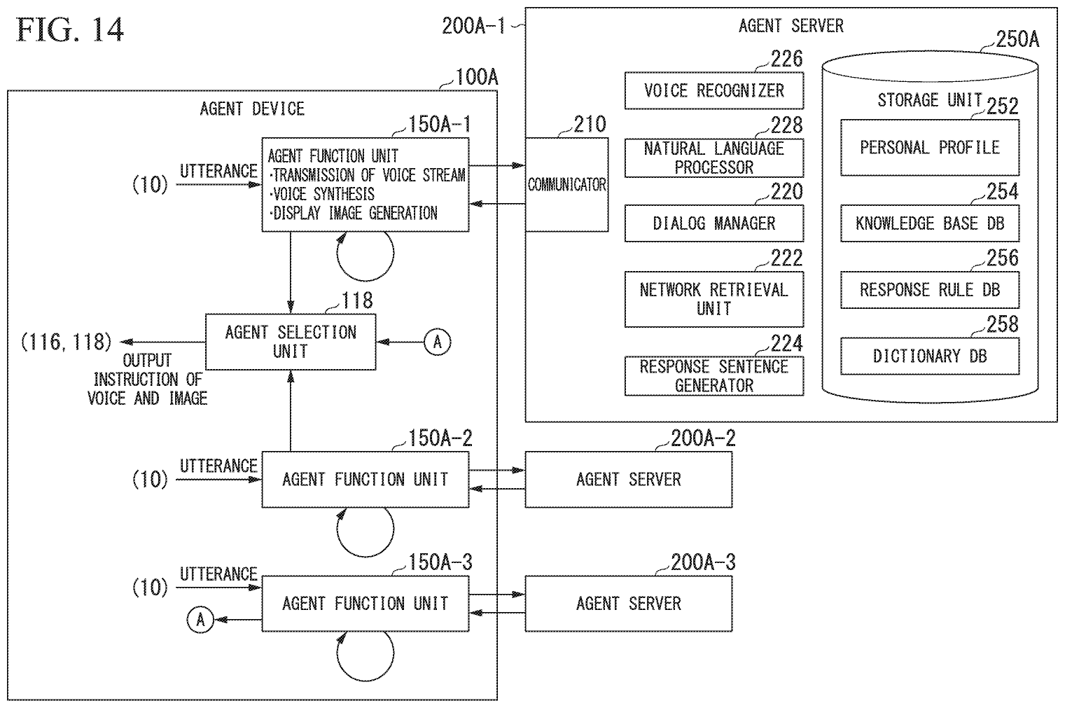

FIG. 14 is a diagram illustrating a constitution of agent servers 200A-1 to 200A-3 according to the second embodiment and a part of a constitution of the agent device 100A. The constitution of the agent servers 200A-1 to 200A-3 and operations of the agent function units 150A-1 to 150A-3 or the like will be described below. It is assumed that a description will be provided below by mainly focusing on the agent function unit 150A-1 and the agent server 200A-1.

The agent server 200A-1 is different from the agent server 200-1 in the first embodiment in that the agent server 200A-1 has a voice recognizer 226 and a natural language processor 228 added thereto and a dictionary DB 258 added to a storage unit 250A. Therefore, a description will be provided below by mainly focusing on the voice recognizer 226 and the natural language processor 228. The combination of the voice recognizer 226 and the natural language processor 228 is an example of a “recognizer.”

The agent function unit 150A-1 performs acoustic processing on a voice collected through an individually assigned microphone 10 and transmits a voice stream which has been subjected to acoustic processing to the agent server 200A-1. When the voice stream is acquired, the voice recognizer 226 in the agent server 200A-1 outputs character information which has been subjected to voice recognition by the voice recognizer 226 and has been subjected to text and the natural language processor 228 performs semantic interpretation on the character information with reference to the dictionary DB 258. The dictionary DB 258 is obtained by associating abstracted semantic information with the character information and may include list information of synonyms and similar words. The dictionary DB 258 may include different data for each of the agent servers 200. Stages of the process of the voice recognizer 226 and the process of the natural language processor 228 are not clearly divided and the processes may be performed while interacting with each other like the fact that the processing result of the natural language processor 228 is received and the voice recognizer 226 corrects the recognition result or the like. The natural language processor 228 may recognize the meaning of the character information using artificial intelligence processing such as machine learning processing using probability or may generate a command based on the recognition result.

The dialog manager 220 determines the content of the utterance to the occupant of the vehicle M with reference to the personal profile 252, the knowledge base DB 254, and the response rule DB 256 on the basis of the processing result (the command) of the natural language processor 228.

[Processing Flow]

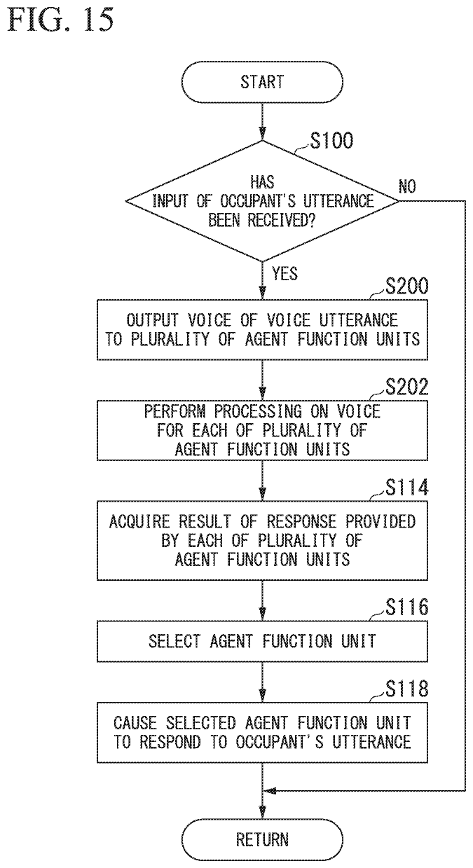

FIG. 15 is a flowchart for describing an example of a flow of a process performed using the agent device 100A in the second embodiment. The flowchart illustrated in FIG. 15 is different from the flowchart in the first embodiment of FIG. 12 described above in that, in the flowchart illustrated in FIG. 15, the processes of Steps S200 to S202 are provided instead of the processes of Steps S102 to S112. Therefore, a description will be provided below by mainly focusing on the processes of Steps S200 to S202.

When it is determined that in the process of Step S100 that an input of the occupant's utterance has been received, the manager 110A outputs a voice of the utterance to a plurality of agent function units 150A-1 to 150A-3 (Step S200). Each of the plurality of agent function units 150A-1 to 150A-3 performs a process on the voice (Step S202). The processing of Step S202 includes, for example, acoustic processing, voice recognition processing, natural language processing, dialog management processing, network retrieval processing, response sentence generation processing, and the like. Subsequently, the agent selector 118 acquires the result of the response provided through each of the plurality of agent function units (Step S114).

According to the agent device 100A in the above second embodiment, in addition to the same effect as the agent device 100 in the first embodiment, it is possible to perform voice recognition in parallel for each of the agent function units. According to the second embodiment, the microphone is assigned to each of the agent function units and the voice from the microphone is subjected to voice recognition. Thus, it is possible to perform appropriate voice recognition even when voice input conditions differ for each agent or a unique voice recognition technique is used.

Each of the first embodiment and the second embodiment described above may be may be combined with some or all of the other embodiments. Some or all of the functions of the agent device 100 (100A) may be included in the agent server 200 (200A). Some or all of the functions of the agent server 200 (200A) may be included in the agent device 100 (100A). That is to say, the separation of the functions in the agent device 100 (100A) and the agent server 200 (200A) may be appropriately changed in accordance with the constituent elements of each device, the scales of the agent servers 200 (200A) and the agent system 1, and the like. The separation of the functions in the agent device 100 (100A) and the agent server 200 (200A) may be set for each vehicle M.

While the modes for carrying out the present invention have been described above using the embodiments, the present invention is not limited to such embodiments at all and various modifications and substitutions are possible without departing from the gist of the present invention.

What is claimed is:

1. An agent device, comprising:
a plurality of agent function units, each of the plurality of agent function units being configured to provide a service including outputting a response to an output unit in response to an utterance of an occupant of a vehicle;
a recognizer configured to recognize a request included in the occupant's utterance; and
an agent selector configured to output a request recognized by the recognizer to the plurality of agent function units and select an agent function unit which outputs a response to the occupant's utterance to the output unit among the plurality of agent function units on the basis of the results of a response of each of the plurality of agent function units.

2. An agent device, comprising:
a plurality of agent function units, each of the plurality of agent function units including a voice recognizer which recognizes a request included in an utterance of an occupant of a vehicle and configured to provide a service including outputting a response to an output unit in response to the occupant's utterance; and
an agent selector configured to select an agent function unit which outputs a response to the occupant's utterance to the output unit on the basis of the results of a response of each of the plurality of agent function units with respect to the utterance of the occupant of the vehicle.

3. The agent device according to claim 2,
wherein each of the plurality of agent function units includes a voice receiver configured to receive a voice of the occupant's utterance and a processor configured to perform processing on a voice received by the voice receiver.

4. The agent device according to claim 1, further comprising:
a display controller configured to cause a display unit to display the result of the response of each of the plurality of agent function units.

5. The agent device according to claim 1,
wherein the agent selector preferentially selects an agent function unit in which a time between an utterance timing of the occupant and a response is short among the plurality of agent function units.

6. The agent device according to claim 1,
wherein the agent selector preferentially selects an agent function unit having a high certainty factor for a response to the occupant's utterance among the plurality of agent function units.

7. The agent device according to claim 6,
wherein the agent selector normalizes the certainty factors and selects the agent function unit on the basis of the normalized results.

8. The agent device according to claim 4,
wherein the agent selector preferentially selects an agent function unit acquired through the response result by the occupant among the results of the responses of the plurality of agent function units displayed by the display unit.

9. A method for controlling an agent device causing a computer to execute:
starting up a plurality of agent function units;
providing services including outputting a response to an output unit in response to an utterance of an occupant of a vehicle as functions of the started-up agent function units;
recognizing a request included in the occupant's utterance; and
outputting the recognized request to the plurality of agent function units and selecting an agent function unit which outputs a response to the occupant's utterance to the output unit among the plurality of agent function units on the basis of the result of the response of each of the plurality of agent function units.

10. A method for controlling an agent device causing a computer to execute:
starting up a plurality of agent function units each including a voice recognizer configured to recognize a request included in an utterance of an occupant of a vehicle;
providing services including outputting a response to an output unit in response to the occupant's utterance as functions of the started-up agent function units; and selecting an agent function unit which outputs a response to the occupant's utterance to the output unit on the basis of the result of a response of each of the plurality of agent function units with respect to the utterance of the occupant of the vehicle.
